(19) United States
(12) Patent Application Publication
(10) Pub. No.: US 2026/0169800 A1
(43) Pub. Date: Jun. 18, 2026

(54) LATENCY AND ERROR-HISTORY BASED FABRIC-ATTACHED MEMORY ALLOCATION

(71) Applicant: Hewlett Packard Enterprise Development LP, Spring, TX (US)

(72) Inventors: Venkatesh Nagaraj, Bangalore (IN); Derek Schumacher, Auburn, IL (US); Debdipta Ghosh, Bangalore (IN); Anil Kumar Kalkappa Devabasappanavar, Bangalore (IN)

(21) Appl. No.: 19/071,833

(22) Filed: Mar. 6, 2025

(30) Foreign Application Priority Data
Dec. 12, 2024 (IN) 202411098377

(51) Int. Cl. G06F 9/50

(52) U.S. Cl. CPC G06F 9/5016; G06F 9/5038

(57) ABSTRACT

Examples described herein relate to allocating a low latency, healthy fabric-attached memory resource to a host device for downloading media. A resource composer may receive, from a host device, a request to download media from a pool of fabric-attached memory resources. The resource composer may identify, from the pool, a set of memory resources based on resource latency. The resource composer may group, based on a respective error history of a given memory resource, the set into a first group and a second group, where the respective error history of each of the memory resources in the first group includes fewer errors than the second group. The resource composer may select, from the first group, a memory resource to allocate to the host device and may allocate the memory resource to the host device. The media may be accessible to the host device at the allocated memory resource.

### BACKGROUND

In many cases, server computer systems in rack mounted configurations (e.g., blade servers) do not implement a directly coupled keyboard, mouse or mass storage device (e.g., an optical drive (CD, DVD)). Accordingly, system administrators install media remotely onto servers in a datacenter. In this regard, an administrator may install an operating system (OS) or perform patch management using a network connection instead of using a storage drive physically connected to a server.

### BRIEF DESCRIPTION OF THE DRAWINGS

The following detailed description references the drawings, wherein:

FIG. 1 is a block diagram of a system capable of allocating fabric-attached memory resources to a host device, according to an example;

FIG. 2 is a flow diagram depicting a method for allocating a fabric-attached memory resource to a host device is shown, according to an example;

FIG. 3 illustrates an example memory resource allocation, according to an example;

FIG. 4 is a flow diagram depicting operations for grouping fabric-attached memory resources based on error history and selecting a fabric-attached memory resource to allocate, according to an example;

FIG. 5 is a flow diagram depicting a method for allocating a fabric-attached memory resource to a host device, according to an example;

FIG. 6 is a flow diagram depicting a method for identifying a fabric-attached memory resource to host media is shown, according to an example;

FIG. 7 is a flow diagram depicting a method for allocating fabric-attached memory resource(s) to a plurality of host devices, according to an example;

FIG. 8 illustrates an example memory resource allocation, according to an example; and

FIG. 9 is a block diagram of a computing device for allocating fabric-attached memory resources to a host device, according to an example.

### DETAILED DESCRIPTION

Remote installation of media, such as an identical storage image of optical media (ISO) image, on a single server may depend on a network connection. For instance, to install media (e.g., an image) that is hosted on a local machine or a network share onto a server, the media may be selected for remote mounting. Once mounted to the server, the media may be transferred to the server over a hypertext transfer protocol secure (https) connection, a hypertext transfer protocol (http) connection, or another network port. The speed and reliability of this connection impacts the speed and reliability of this transfer.

Moreover, the complexity of media installation may increase as a datacenter grows, as installation of media over multiple servers is influenced by several additional parameters. In this regard, network latency, congestion, and bandwidth may influence the efficiency at which media is deployed across the datacenter. In addition, with media deployed to an increasing number of servers, concerns over security, session management, and the availability of a target server's hardware resources deepen. Such challenges and inefficiencies in a datacenter may delay installation of media and may result in unmet service level agreements (SLAs) at a customer's end.

Examples described herein relate to hosting media, such as a bootable image (e.g., an ISO image), in shared, fabric-attached memory (FAM), such as shared Compute Express Link (CXL) memory. FAM refers to a shared pool of memory that is accessible to one or more hosts (e.g., servers), over a network fabric. FAM as a concept disaggregates memory from compute resources, allowing memory capacity to grow independently of compute capacity. In some cases, FAM may be implemented in a memory semantic fabric. A network may include a number of fabric-attached memory devices, such as single logical devices (SLDs) and/or multiple logical devices (MLDs). The memory resources of these memory devices (which may be referred to herein interchangeably as “fabric-attached memory resources” or “memory resources”) may form pooled resources and may be shared.

According to some aspects of the instant application, media, such as a combination of an ISO image, a bootable image, an operating system, software, firmware, or the like, is hosted (e.g., stored) on a shared fabric-attached memory resource and made available to host devices (e.g., a server or other processing device). By hosting the media in a fabric-attached memory resource, the media may be installed at a host device without the host being directly coupled to a mass storage device. Moreover, multiple host devices can access and/or reuse the media stored at the memory resource. For instance, a single instance of a media hosted in a shared fabric-attached memory device may be downloaded by multiple different host devices for installation at those devices. Further, in some cases, various memory resources may host respective instances (e.g., copies) of the media so that multiple instances of the media may be available to host devices. With the high bandwidth of FAM, such as CXL-based FAM, media may be downloaded with lower latency than other network connections, such as http or https connections.

To download and/or install media stored at a memory resource, a host device may request access to the media. When a host device requests access to media hosted on fabric-attached memory, a fabric-attached memory resource may be allocated to the host device so that media at that memory resource is available to the host device. In some cases, this allocation is performed based on the availability of the resource. However, allocating a memory resource without an assessment of the latency and/or error history (e.g., resource health) associated with the resource may impact the efficiency and reliability of the media download. In this regard, higher latency between a memory resource and a host device may result in decreased efficiency of the media download. A history of greater and/or more severe errors at a memory resource may result in greater unreliability of the media download.

To address these issues, examples described herein relate further to allocating a fabric-attached memory resource to a host device such that the host device can download media from the fabric-attached memory resource. In allocating the fabric-attached memory resource, the memory resource may be selected such that various attributes associated with the memory resource are optimized. These attributes may include resource latency, resource error history (e.g., health status), the media (e.g., image) hosted by the resource, and the like. For instance, a fabric-attached memory resource that is closer to a host device may be prioritized for selection over a fabric-attached memory resource that is farther from a host device and may thus have greater latency. Similarly, a fabric-attached memory resource with fewer and/or less severe errors in its history (e.g., better health properties) may be prioritized for selection over a fabric-attached memory resource that has worse health properties (e.g., greater errors). Allocating a fabric-attached memory resource having a lower latency between the resource and the host device may result in increased efficiency of a media download, and allocating a fabric-attached memory resource having a superior health status (e.g., reflecting a history of fewer errors) may result in greater reliability of the media download.

Allocating memory resources to multiple host devices, which may each request multiple different media, may involve identifying (based on latency, error history, and/or the like) a set of candidate resources for each host device. From the sets of candidate resources, a matching may be determined that optimizes memory resource allocation across multiple host devices. As an illustrative example, a first and a second memory resource may be identified as candidate resources for a first host device, and the first memory resource and a third memory resource may be identified as candidate resources for a second host device. In some cases, a matching may allocate the first memory resource to the first host device and may allocate the third memory resource to the second host device. Such matchings may be determined based on optimizing attributes, such as resource latency and resource health, across multiple host devices.

As described herein, the term “resource latency” may represent the delay between the host device and the fabric-attached memory resource, such as the time, number of instruction cycles, or the like to access the fabric-attached memory resource from the host device. This latency may be influenced by various factors, including physical distance between the fabric-attached memory resource and the host device, network congestion, switch processing time, switch buffering, and the like. As described herein, the term “error history” may relate to a health status of a fabric-attached memory resource and may reflect a number and/or severity of errors experienced by the memory resource. For example, in some cases, a memory resource may degrade over time, resulting in increasing errors. For a memory resource hosting media, these errors may degrade the media itself. Additionally or alternatively, the errors may impact the reliability of a copy of the media downloaded from the memory resource.

It may be appreciated that while the operations involved in allocating a fabric-attached memory resource are described herein in a particular order, the order can be different. For instance, a fabric-attached memory resource may be identified based on resource health and/or the media it hosts prior to resource latency. Moreover, fewer or additional attributes may be used to select the fabric-attached memory resource for allocation to a host device. In this regard, consideration of resource health or resource latency may be omitted from the allocation, and consideration of a media's attributes, such as whether the media is a signed or unsigned version, may be included in the allocation.

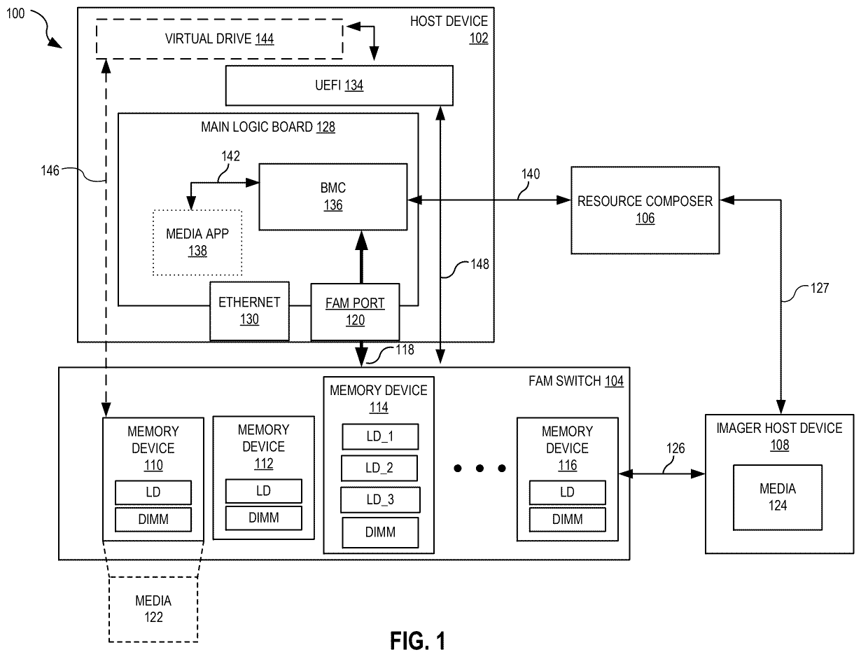

FIG. 1 is a block diagram of a system 100 capable of allocating fabric-attached memory resources to a host device, according to some examples. The system 100 can include a host device 102, a FAM switch 104, a resource composer 106, an imager host device 108, and a number of fabric-attached memory devices 110-116. In certain examples, the host device 102, the resource composer 108, and/or the imager host device 108 are computing devices, such as servers, client computers, desktop computers, mobile computers, etc. In other examples, the host device 102, the resource composer 108, and/or the imager host device 108 can include special purpose machines. The host device 102, the resource composer 108, and/or the imager host device 108 can be implemented via a processing element, memory, and/or other components. Moreover, in some examples, resource composer 106 and/or imager host device 108 may be examples of a host device, such as host device 102. For simplicity, host device 102 is shown in greater detail; however, it may be appreciated that resource composer 106 and/or imager host device 108 may include components illustrated and described herein with respect to host device 102.

The FAM switch 104 may be a switch that couples host devices, such as host device 102, to memory device(s), such as memory device 110-116. The FAM switch 104 may include a number of upstream ports for coupling to host devices and a number of downstream ports for coupling to memory devices. More specifically, an upstream port can be coupled to a FAM port of a host device, as illustrated by arrow 118 between FAM switch 104 and FAM port 120 of the host device 102. Moreover, while the FAM switch 104 is illustrated as containing memory device 110-116, the FAM switch 104 may additionally or alternatively be communicatively coupled to memory devices external to the FAM switch 104 via, for example, a downstream port. In some examples, the FAM switch 104 may be a CXL switch.

The memory resources (e.g., memory space) of memory devices 110-116 (which may be referred to herein interchangeably as “fabric-attached memory resources” or “memory resources”) may form pooled resources, which may be accessed and shared by different host devices. In particular, the memory resources may be used to host media 122 that may be accessed by a host device for download

As described herein, the imager host device 108 may be a computing device, such as a server. In some examples, the imager host device 108 may host (e.g., store) media 124. The imager host device 108 may write (e.g., copy) the media 124 onto one or more memory devices, such as memory devices 110-116. As described herein, writing media to a memory device relates to writing content of the media, which may include any combination of data, file(s), folder(s), representations thereof, and/or the like, to the memory device. In this regard, the media 122 hosted at memory device 110 may be a copy of the media 124 hosted by the imager host device 106. In writing the media 124 onto a memory device, the imager host device 106 may maintain a configuration of the media 124 so that the media 124 may be deployed at the host device 102. For instance, in cases where the media 124 is an image (e.g., a bootable image), the imager host device 106 may write content of the image and its organization (e.g., structure) to a memory device. Writing the content of the media 124 to a device may alternatively be referred to as flashing the media 124. Moreover, the imager host device 108 may be communicatively coupled to the FAM switch 104 and/or the memory devices 110-116, as illustrated by arrow 126. The imager host device 108 may communicate the media 124 to a memory device via this coupling. In some examples, the imager host 108 may be coupled to the FAM switch 104 via a FAM port 120.

The resource composer 106 may be a computing device that operates as a fabric manager or an orchestrator of other fabric managers. In this regard, the resource composer 106 may be a scalable management platform for configuring and administrating a fabric, such as a fabric that includes the components of system 100. In some examples, the resource composer 106 may be configured to request and/or obtain information from components of system 100, which may be included in a datacenter and implemented as a fabric. The resource composer 106 may, for example, utilize a Representational State Transfer (REST) Application Programming Interface (API), such as RedFish API, to communicate with and/or coordinate components of system 100.

According to some examples, host device 102 may request media for download, and responsive to the request, resource composer 106 may allocate a fabric-attached memory resource to the host device 102. The requested media may be any combination of an ISO image, a bootable image, an operating system, software, firmware or the like. As described in greater detail below, the resource composer 106 may allocate the fabric-attached memory resource based on attributes of the memory resource, such as a latency associated with the memory resource and/or an error history of the memory resource. For instance, the resource composer 106 may select a fabric-attached memory resource with relatively low latency and few errors in its error history to allocate to the host device 102 such that the host device 102 may download media with low latency and high reliability. The host device 102 may download the media from the allocated fabric-attached memory resource and may install the media.

As illustrated, a host device 102 may include a main logic board 128, an ethernet port 130, a FAM port 120, and a unified extensible firmware interface (UEFI) 134. The main logic board 128 may be a motherboard or other circuit board of the host device 102. The host device 102 may include one or more central processing units (CPUs), with each CPU running or being capable of running an operating system (OS). For simplicity of illustration, individual CPUs or processors are not shown in host device 102 in FIG. 1.

As illustrated, the main logic board 128 may include a baseboard management controller (BMC) 136, which, in some examples, may be a microcontroller. The BMC 136 may interface between hardware of the host device 102 and a management system, such as resource composer 106. The BMC 136 may also communicate monitored data of the host device 102. For instance, hardware sensors of the host device 102 (not shown) may monitor the health, operating system (OS) status, power status, etc., of the host device 102 and report monitored data to the BMC 136 of the host device 102.

In some examples, the host device 102 may request media for download via the BMC 136. More specifically, the BMC 136 may transmit the request to the resource composer 106. In this regard, the BMC 136 is illustrated as being communicatively coupled to the resource composer 106, as shown by arrow 138. In some cases, the host device 102 may access media from a fabric-attached memory resource allocated by the resource composer 106 via the FAM port 120.

The FAM port 120 may be included on the main logic board 228, such as on the BMC 136, or on another portion of the host device 102, such as a CPU of the host device 102. The BMC 136 may be communicatively coupled (as shown by arrow 118) to the FAM port 120. In some cases, the host device 102 may initialize the FAM port 120 during power-on self-test (POST) and may then acquire memory from the allocated fabric-attached memory resource based on the request transmitted by the BMC 136 to the resource composer 106. As an illustrative example, the host device 102 may, via the FAM port 120, access media 122 from a fabric-attached memory resource allocated from memory device 110.

In some cases, the host device 102 may include a media application (app) 138, which may be implemented via a processing element, memory, and/or other component. In some cases, for example, the media app 138 may be a functionality of the BMC 136. The media app 138 may project media from an allocated fabric-attached memory resource to the host device 102 as a virtual drive 144, as shown by dashed arrow 146. In this regard, the media app 138 may present the media hosted at a fabric-attached memory resource, such as media 122, to the host device 102 such that, from the perspective of the host device 102, it appears as though the media is hosted locally. While the dashed arrow 146 is shown as extending directly from memory device 110 to the virtual drive 144, it may be appreciated that the host device 102 may access media hosted at a memory device, such as memory device 110, via the FAM port 120.

The UEFI 134 may recognize the virtual drive 144 and may launch installation of media from the virtual drive 144. For instance, the UEFI 134 may launch installation of software, an OS, or the like from media presented at the virtual drive 144.

In some examples, the media app 138 is an optional component of host device 102, as shown by the dotted border of media app 138 in FIG. 1. In this regard, instead of using the media app 138 to project a virtual drive 144, the host device 102 may use a driver hosted as an application at the UEFI 134 to access the media hosted by an allocated fabric-attached memory resource. In such cases, the UEFI 135 may install and/or boot media directly from the driver, as illustrated by arrow 148. The driver may be implemented via a processing element, memory, and/or other component.

In some cases, the resource composer 106 may allocate a memory resource that hosts media requested by the host device 102 to the host device 102 for download. For instance, the resource composer 106 may allocate a memory resource of the memory device 110 to the host device 102 in response to a request to download the media 122. Additionally or alternatively, the resource composer 106 may select a memory resource to host the media. For instance, in some examples, the resource composer 106 may direct the imager host device 108 to write the media 124 (e.g., write content of the media 124) onto one or more memory devices 110-116. Accordingly, the resource composer 106 may be communicatively coupled to the imager host device 108, as indicated by arrow 127.

As described in greater detail below, the resource composer 106 may select a fabric-attached memory resource to host a copy of the media, such as media 122, based on attributes of the memory resource, such as a resource latency associated with the fabric-attached memory resource and/or an error history of the fabric-attached memory resource. In some examples, the resource composer 106 may determine a number of memory resources to write a media to based on a number of host devices requesting the media, based on a topology of the data center (e.g., to provide media at different memory resources each having a relatively low latency to different host devices), based on a pre-configured setting of the resource composer 106, based on an input (e.g., a user input) received at the resource composer 106, or the like. Further, in some examples, the resource composer 106 may direct and/or the imager host device 108 may be configured to periodically refresh a copy of the media by writing the content of the media to a different memory resource or writing a fresh copy of the media to a memory resource currently hosting the media. In this manner, the impact of a copy of media degrading over time may be reduced, as an undegraded copy of the media may be maintained.

For ease of illustration, system 100 is shown as having a single host device 102, FAM switch 104, resource composer 106, and imager host device 108, as well as memory devices 110-116. Yet, it may be appreciated that the system 100 may include any number of host devices, FAM switches, imager host devices, and memory devices. In this regard, the system 100 may illustrate a portion of a fabric, which may be hosted in a datacenter. The datacenter may include hundreds of host devices, FAM switches, and memory devices. In some cases, a single resource composer 106 may coordinate the components of the fabric, and in others, multiple resources composers may coordinate together to coordinate the components of the fabric.

Memory devices 110-116 may include one or more logical devices (LDs) backed by a dual in-line memory module (DIMM). In the illustrated example, memory devices 110, 112, and 116 are single logical devices (SLDs), and memory device 114 is a multiple logical device (MLD). In this regard, memory device 115 is shown as partitioned into three logical devices (e.g., LD_1, LD_2, and LD_3). A fabric-attached memory resource may be memory provided by an SLD memory device, a partition of memory provided by an MLD memory device, or the like. It may be appreciated that the system 100 may include any combination of SLDs and MLDs. In some examples, memory devices 110-116 may be CXL-enabled memory devices, and the memory resources may be CXL memory resources.

As represented by arrows 118, 126, 127, 140, and 142, components of the system 100 may be communicatively coupled. The communicative coupling represented by arrows 118, 126, 127, 140, and 142 may encompass a wired coupling, a wireless coupling, or a combination thereof. A wireless coupling may include, for example, a network connection, such as an Internet connection, a local area network (LAN) connection, a wide area network (WAN) connection, or the like.

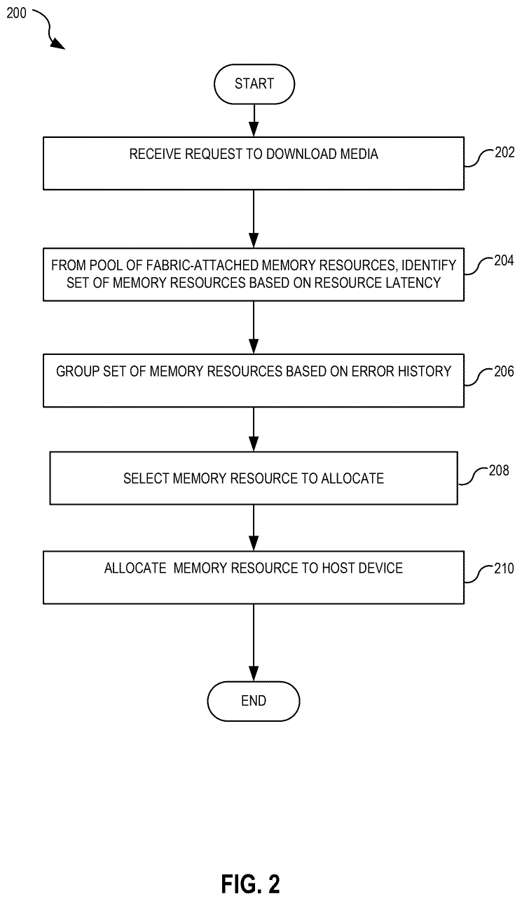

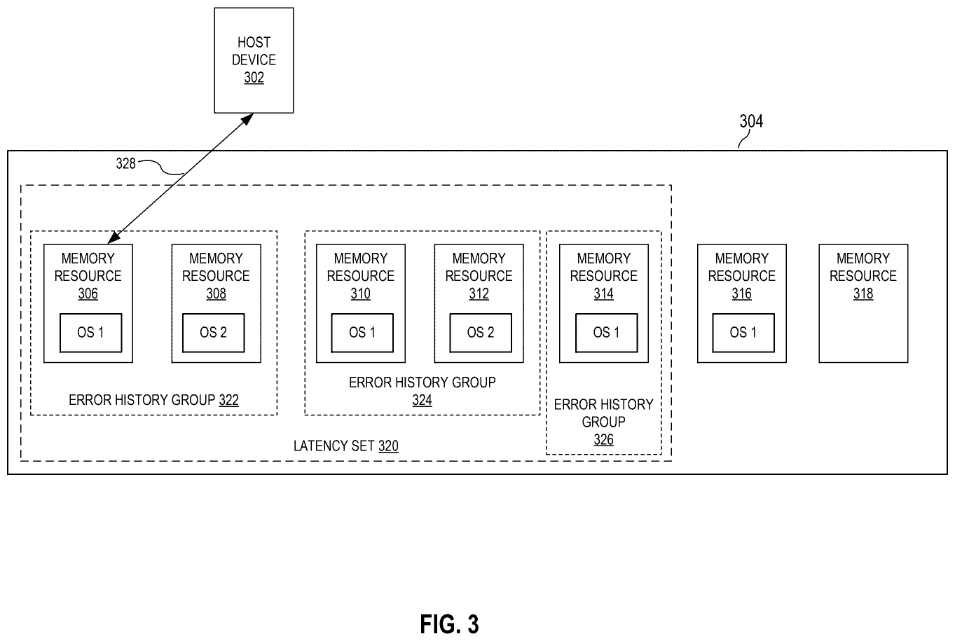

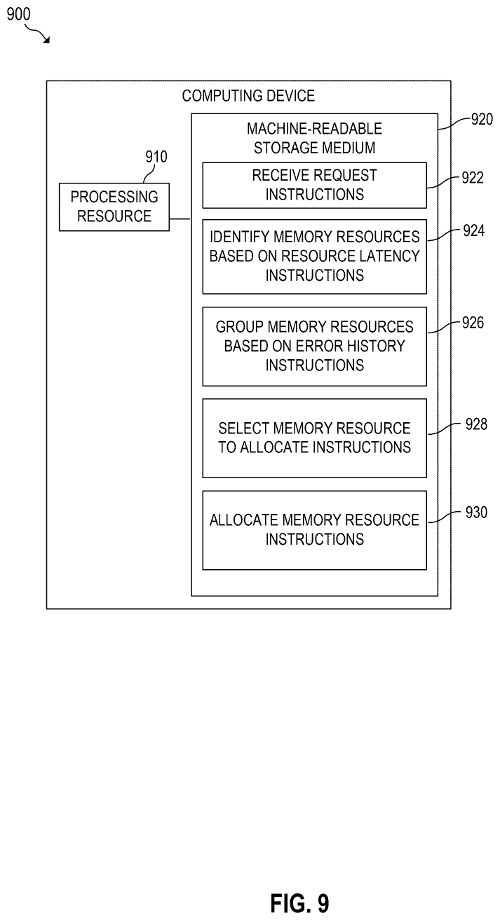

Referring now to FIG. 2, a flow diagram depicting a method 200 for allocating a memory resource to a host device is shown, in accordance with an example. For illustration purposes, the method 200 will be described in conjunction with the example memory resource allocation shown in FIG. 3. The method 200 may include method blocks 202, 204, 206, 208, and 210 (hereinafter collectively referred to as blocks 202-210) which may be performed by a computing device such as, for example, the resource composer 106 (FIG. 1). In particular, operations at each of the method blocks 202-210 may be performed by the computing device, such as a resource composer, by executing the instructions stored in a machine-readable medium, as described below with reference to FIG. 9

Moreover, it is to be noted that in some examples, the order of execution of the blocks 202-210 may be different than that shown in FIG. 2. For example, blocks may be added or omitted, and the blocks 202-210 may be performed in series, in parallel, or a series-parallel combination.

Method 200 may start at block 202, where a resource composer, such as resource composer 106 (FIG. 1), may receive a request to download media. The request may be a request to download the media from a pool of fabric-attached memory resources. In some cases, the resource composer may receive the request from a host device, and the request may be a request to download the media at that host device. In other cases, the resource composer may receive the request from a first host device, and the request may be a request to download the media at a different, second host device. Further, the requested media may be an ISO image, a bootable image, an OS, or the like.

In the example resource allocation illustrated in FIG. 3, a request may be received from host device 302 to download media from a pool 304 of fabric-attached memory resources at the host device 302. The host device 302 may be an example of the host device 102 (FIG. 1). The pool 304 of fabric-attached memory resources may include fabric-attached memory resources (e.g., memory resources 306-318) accessible to (e.g., capable of being in communication with) the host device 302. In this regard, while not shown, each of the memory resources 306-318 in the pool 304 may be coupled to the host device 302 via a path including one or more FAM switches, such as FAM switch 104 (FIG. 1). Each of the memory resources 306-318 may be the memory space or a portion thereof provided by a memory device. For instance, a memory resource may be the memory provided by an SLD memory device (e.g., memory device 110 (FIG. 1)), a partition of the memory provided by an MLD memory device (e.g., memory device 114 (FIG. 1)), or the like. Moreover, while labeled “Memory Resource,” it may be appreciated that the memory resources 306-318 are fabric-attached memory resources.

At block 204 of the method 200, the resource composer may, from a pool of fabric-attached memory resources, identify a set of memory resources based on resource latency. In some cases, the resource composer may identify the memory resources having the lowest resource latency between the host device for the set. In this regard, the resource composer may identify the set of memory resources such that a lowest resource latency for the host device is between the host device and each of the set of memory resources.

In determining the set of memory resources, the resource composer may determine the latency between a memory resource and the host device. The resource composer may determine the latency between a memory resource and the host device by determining the delay (e.g., in time or instruction cycles) for the host device to access the memory resource. The resource composer may additionally or alternatively determine the latency based on a path length (e.g., a number of FAM switches) between a memory resource and a host device. Further, in some cases, the resource composer may determine the latency based on a physical distance between the memory resource and the host device. In some cases, the resource composer may be preprogrammed with information relevant to the latency, such as predetermined delay information, datacenter topology information, or the like. In other cases, the resource composer may determine the latency by requesting relevant information from devices (e.g., host devices, switches, memory devices in the like) in the datacenter.

In some cases, the resource composer may identify the set of memory resources by grouping the pool of fabric-attached memory resources based on resource latency and identifying the set as the group of memory resources having the lowest resource latency. In some examples, grouping memory resources may involve grouping resources having substantially similar resource latency with the host device together. In such cases, the resource latency between the host device and memory resources having the lowest resource latency may be substantially similar. The lowest resource latency may be a particular value, for example. As an illustrative example, the resource composer may identify the set of memory resources as the memory resources having a resource latency of approximately 10 milliseconds with the host device. In other examples, grouping memory resources may involve grouping resources having a resource latency with the host that falls within a range of latencies. For instance, groupings may include resource latencies within a nanosecond of each other, 10 nanoseconds of each other, a millisecond of each other, 10 milliseconds of each other, or the like. In such cases, the resource latency between the host device and memory resources having the lowest resource latency may fall within the range of latencies included in the lowest latency group. As an illustrative example, the resource composer may identify the set of memory resources as the memory resources having a resource latency between 10 and 15 milliseconds with the host device.

In some examples, the resource composer may identify the set of memory resources based on a respective resource latency between each of the set of memory resources and the host device satisfying a threshold. The threshold may be a certain delay time (e.g., in nanosecond(s), millisecond(s)), a number of instruction cycles, a number of switches in a path length, or a physical distance between the host device and the memory resources. In some cases, the threshold may be a predetermined (e.g., preconfigured) threshold. For instance, the resource composer may identify the set of memory resources as the resources having a resource latency with the host device of 10 milliseconds or less. In other cases, the threshold may be the lowest resource latency. In such cases, the resource composer may determine the lowest resource latency between the host device and a memory resource in the pool and may identify each of the memory resources satisfying this latency.

Turning to the example allocation shown in FIG. 3, the resource composer may, from the pool 304, identify the latency set 320 as a set of memory resources based on resource latency. In particular, the resource composer may identify the latency set 320 based on the latency between the host device and each of the memory resources of the latency set 320 being the lowest resource latency for the host device. In such cases, the resource latency between the host device 302 and each of the memory resources 316-318 may exceed the lowest resource latency. Additionally or alternatively, the resource composer may identify the latency set 320 based on the resource latency between the host device 302 and each of the memory resources 306-314 included in the latency set 320 satisfying a threshold. In such cases, the resource latency between the host device 302 and each of the memory resources 316-318 may fail to satisfy this threshold.

Returning to FIG. 2, at block 206 of the method 200, the resource composer may group the set of memory resources based on error history. The resource composer may, for example, subdivide the set of memory resources identified at block 204 into different groups (e.g., subsets) based on a respective error history of the memory resources in the set. In some cases, the resource composer may group the set of memory resources into a first group and a second group, where the respective error history of each of the memory resources in the first group includes fewer errors than the respective error history of each of the memory resources in the second group. As an illustrative example, the first group may be a group of memory resources having no errors in their respective error histories, while the second group may include one or more errors in their respective error histories.

In some examples, the resource composer may group memory resources into one or more of a “zero error group”, a “warning group”, a “serious group”, and a “critical group.” The “zero error group” may correspond to a resource having no errors in its error history, and the “warning group,” the “serious group,” and the “critical group” may respectively correspond to increasing numbers of errors in a resource's error history. In some examples, the “critical error group” may additionally or alternatively correspond to a resource that has crashed and has not received subsequent maintenance. While a first and second group, as well as the zero error, warning, serious, and critical groups have been described herein, it may be appreciated that memory resources may be grouped into any number of groups based on error history.

To illustrate block 206, in the example shown in FIG. 3, the resource composer may group memory resources 306-314 within the latency set 320 into a first error history group 322, a second error history group 324, and a third error history group 326. The number and/or severity of errors in a respective memory resource's error history may increase from the first error history group 322 to a second error history group 324 and from the second error history group 324 to the third error history group 326. For instance, memory resource 306 may be placed in the first error history group 322 based on having no errors, memory resource 310 may be placed in the second error history group 324 based on having one error in its history, and memory resource 314 may be placed in the third error history group 326 based on having two or more errors in its history.

At block 208 of the method 200, the resource composer may select a memory resource to allocate. In some examples, the resource composer may select the memory resource from among the groups created at block 206 and may prioritize selecting a memory resource from a group with the fewest and/or least serious errors in its error history. For instance, in the example described above involving a first group and a second group, the resource composer may select a memory resource from the first group to allocate to the host device, as a resource from this group may have fewer errors in its history than a memory resource from the second group. Similarly, selecting the resource may involve selecting a resource from the subset of resources grouped into the “zero error group” if there is one available. If such a resource is not available or does not exist, selecting the resource may involve looking to the subset of resources grouped into the “warning group” before looking to the “serious group.”

In some examples, the resource composer may select the memory resource to allocate further based on determining the memory resource hosts the requested (at block 202) media. In some examples, the resource composer may determine the memory resource hosts the requested media based on recorded usage of the memory resource. For instance, the resource composer may maintain a record of the memory resource's usage and may determine the memory resource hosts the media based on this record. In some cases, for example, the resource composer may update the record of the memory resource's usage to reflect that the resource hosts the media based on the resource composer instructing a host imager device (e.g., imager host device 108 (FIG. 1)) to write the media (e.g., write content of the media) onto the memory resource. Additionally or alternatively, the resource composer may determine that the memory resource hosts the requested media based on a response from a memory device to a request from the resource composer that reflects whether the memory resource hosts the requested media.

In the example illustrated in FIG. 3, the memory resources 306, 310, and 314-316 are shown as hosting a first operating system labeled “OS 1” as an example of media. Memory resources 308 and 312 are shown as hosting a second operating system labeled “OS 2” as another example of media. Memory resource 318 is shown as not hosting media. In response to a request from host device 302 to download the first operating system (at block 202), the resource composer may, at block 208 select memory resource 306 for allocation to the host device 302 based on the memory resource 306 being in the first error history group 322, based on the memory resource 306 hosting the first operating system (“OS 1”), or a combination thereof.

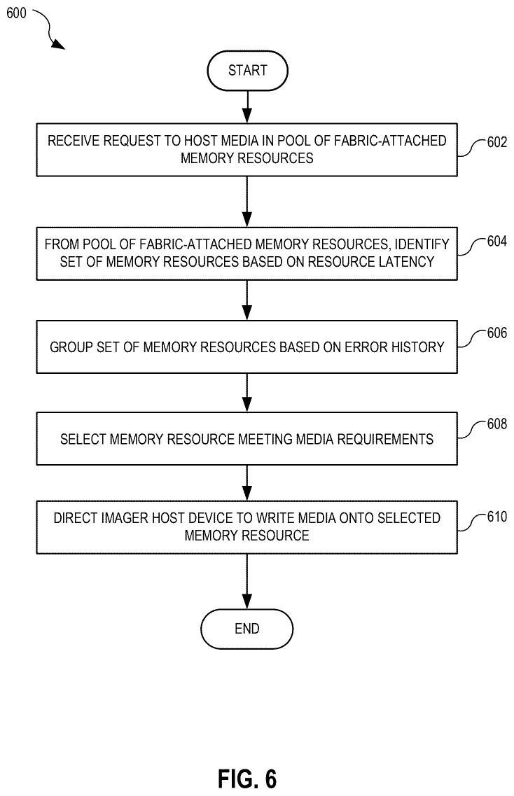

As described in greater detail with reference to FIG. 6, in some cases, the resource composer may (at block 208) select a memory resource even if it does not host the requested media. For instance, the resource composer may select the memory resource based on the resource latency and/or the error history of the resource even if the resource does not host the media. In such cases, the resource composer may select the memory resource to host the media and may direct the imager host device to write content of the media onto the selected resource.

In some examples, at block 208, the resource composer may select the memory resource to allocate based on determining that the memory resource hosts a signed image version of the media. In some cases, for example, the resource composer may prioritize a memory resource hosting a signed image version of the media for allocation over a memory resource hosting an unsigned image version. The resource composer may determine that the memory resource hosts the signed image version based on a record of the memory resource's usage or based on information requested by the resource composer from the memory resource.

In some examples, the request to download the media (at block 202) is to download one or more of a first media and a second media. For instance, a host device may request to download a first operating system and/or a different, second operating system. In such cases, at block 208, the resource composer may select the memory resource based on the memory resource hosting the first media or the second media. The resource composer may make this determination using the techniques described above with respect to the media hosted at a memory resource.

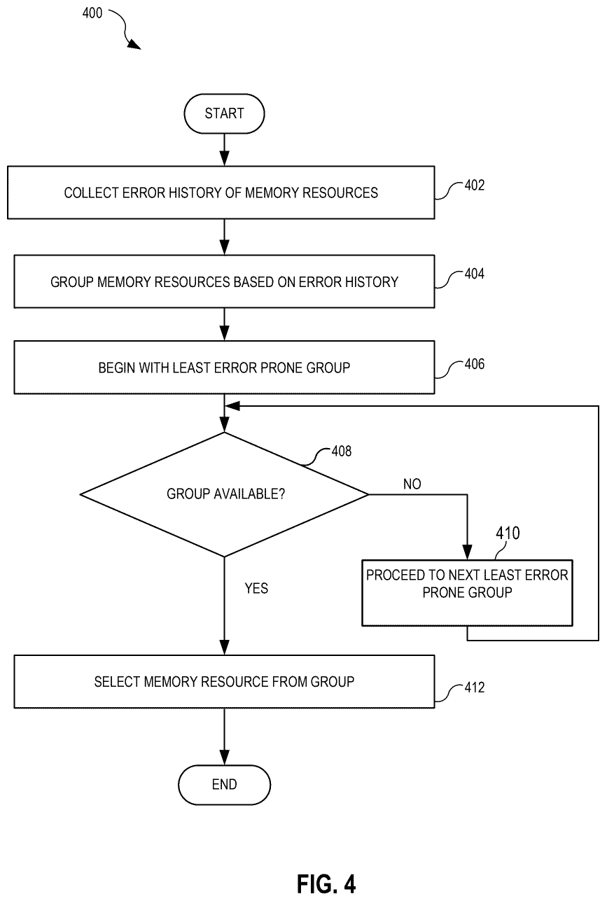

Turning now to FIG. 4, a flow diagram depicting operations for grouping memory resources based on error history and selecting a memory resource to allocate, in accordance with an example of blocks 206-208 (FIG. 2), is shown. As described with reference to FIG. 2, the method blocks 402, 404, 406, 408, 410 and 412 (hereinafter collectively referred to as blocks 402-412) may be performed a computing device such as, for example, the resource composer 106 (FIG. 1). In particular, operations at each of the method blocks 402-412 may be performed by the computing device, such as a resource composer, by executing the instructions stored in a machine-readable medium, as described below with reference to FIG. 9. Further, it is to be noted that in some examples, the order of execution of the blocks 402-412 may be different than that shown in FIG. 4. For example, blocks may be added or omitted, and the blocks 402-412 may be performed in series, in parallel, or a series-parallel combination.

Method 400 may start at block 402, where a resource composer, such as resource composer 106 (FIG. 1), may collect an error history from memory resources. In some cases, for example, the resource composer may collect error histories from each memory resource in a pool (e.g., pool 304 (FIG. 3)) or a subset thereof. The resource composer may collect the error histories by requesting the error histories from the memory devices providing the memory resources. For instance, the resource composer may, using a RedFish API call, request the error history and may receive a response from a memory device.

At block 404, the resource composer may group memory resources based on their respective error history. The resource composer may generally perform the operations of block 404 as described herein with respect to block 206 of FIG. 2. In this regard, the resource composer may group memory resources into different groups (e.g., subsets) based on a respective error history of the memory resources. While block 206 was described with respect to identifying a set based on latency and grouping the set based on error history, it may be appreciated that memory resources may be grouped based on error history before, after, or in parallel with identifying memory resources based on latency. As such, at block 404, resource composer may group memory resources from a pool, from a set of resources identified based on latency, or the like.

At block 406, to prioritize allocating a memory resource from a group having the fewest errors in its error history, the resource composer may begin with the least error prone group of the groups created at block 404. For instance, between a first group having an error history with fewer errors than a second group, the resource composer may, at block 406, begin with the first group. Similarly, in cases where there is a “zero error group”, reflecting an error history with no errors, the resource composer may begin with the “zero error group”. If such a group does not exist, the resource composer may begin with a “warning group” before looking to the “serious group.” With respect to the example allocation illustrated in FIG. 3, for instance, the resource composer may begin with the first error history group 322.

At block 408, the resource composer may determine whether the current group is available. In some cases, determining whether a group is available may involve determining whether a memory resource in the group hosts the requested media. Determining whether a group is available may additionally or alternatively involve determining whether any of the memory resources in the group have a bandwidth (e.g., a link bandwidth) to be allocated to the host device. The resource composer may determine whether a memory resource has bandwidth by requesting bandwidth information via, for example, an API call to the memory device. Additionally or alternatively, the resource composer may make such determinations based on record usage of a memory resource.

In cases where a memory resource in the current group hosts the requested image (which may be determined as described herein in accordance with block 208), the resource composer may determine whether the memory resource has the bandwidth to be allocated to the host device. In some cases, the resource composer may determine that the memory resource has sufficient bandwidth in response to determining that the memory resource has no tenant host devices. That is, for example, the memory resource is not allocated to a host device. In cases where a memory resource is already allocated to a host device (e.g., a first tenant host device), the resource composer may determine whether the memory resource has bandwidth to be shared by another host device (e.g., a second tenant host device). The resource composer may treat a memory resource with sufficient bandwidth to be shared as available, and as a result may, at block 408, determine that the group the resource is in is available. Relatedly, the resource composer may treat a memory resource lacking sufficient bandwidth to be shared as not available, and if there are no other memory resources available in the group the resource composer may, at block 408, determine that the group is in is not available.

In some cases, when no memory resource in the current group hosts the requested media (which may be determined as described herein in accordance with block 208), the resource composer may determine that the group is unavailable at block 408 and may proceed to block 410. In other cases, the resource composer may determine whether a memory resource in the group has the storage to host the media and/or the bandwidth to be allocated to the host device. In this regard, the resource composer may determine whether a memory resource in the group is suitable to be written to with the media (e.g., by an imager host device), as described with respect to FIG. 6. The resource composer may make such determinations based on record usage of a memory device and/or based on storage and/or bandwidth information requested from memory devices via API calls, for example. Responsive to identifying a memory resource in the group with sufficient storage to host the media and/or bandwidth to be allocated to the host device, the resource composer may determine that the group is available at block 408 and may proceed to block 412.

Responsive to determining a memory resource in the current group is not available, the resource composer may, at block 410, proceed to the next least error prone group of the groups created at block 404. With respect to the example allocation illustrated in FIG. 3, for instance, if first error history group 322 was unavailable, the resource composer may, at block 410, proceed to the second error history group 324.

Responsive to determining a memory resource in the current group is available, the resource composer may, at block 412 select the memory resource from the group. The resource composer may generally perform the operations of block 408 as described herein with respect to block 208 of FIG. 2. In this regard, the operations of block 406-410 may result in the resource composer prioritizing selecting, at block 412, a memory resource from a group with the fewest and/or least serious errors in its error history. Moreover, based on the operations at block 408, the resource composer may select the memory resource based on determining the memory resource hosts requested media, hosts a signed image version of the media, is suitable to host media, or the like. As described with respect to FIG. 2, the selected memory resource may be allocated to a host device, and as described with respect to FIG. 6, in some cases, the selected memory resource may be selected to be written to with the media.

Turning back to FIG. 2, at block 210 of the method 200, the resource composer may allocate a memory resource to the host device. In particular, the resource composer may allocate the memory resource selected at block 208 to the host device. As described above, the request received (at block 202) may be a request from a host device for downloading the media at the host device or may be a request from a first host device to download the media at a different, second host device. In the first example, the resource composer may allocate the memory resource to the host device, and in the second example, the resource composer may allocate the memory resource to the second host device. In this regard, the resource composer may allocate the memory resource to an appropriate host device based on the request.

In cases where the selected memory resource hosts the requested media, the resource composer may allocate the selected memory resource by binding the selected memory resource to the host device. The resource composer may, for example, communicate the allocation to the host device (e.g., to the BMC 136 (FIG. 1) of the host device). The resource composer may further update a record of the memory resource's usage. Further, in some cases, the resource composer may cache the memory resource allocation to the host device. In such cases, if the same host device requests a memory resource (e.g., requests to download media), then the resource composer can allocate the same memory resource to the host device based on the cache.

As described in greater detail with respect to FIG. 6, in some cases a selected memory resource is not hosting requested media. In such cases, allocating the memory resource to the host device may further involve directing an imager host device (e.g., imager host device 108 (FIG. 1) to write the requested media onto the memory resource.

In the example allocation illustrated in FIG. 3, the allocation of memory resource 306 to the host device 302 is illustrated by arrow 328. Based on a memory resource being allocated to a host device, the host device may access media hosted at the memory resource. For instance, in the illustrated example, host device 302 may access the media “OS 1” hosted at the memory resource 306. In particular, as described with respect to FIG. 1, media hosted at the memory resource may be booted or installed at the host device by the host device based on the allocation.

In some cases, the order of execution of the blocks 202-210 may result in more predictable performance for media download(s) at a host device. For instance, by identifying memory resources having a lowest resource latency and/or satisfying a latency threshold (at block 204), delays between the host device and a memory resource may be predicted and/or reduced, especially in comparison with memory resource allocation that does take resource latency into account. Moreover, by prioritizing memory resources with fewer errors in their error history (at blocks 206-208), the reliability of the media download at the host device may be improved, as memory resources with greater errors may host a more degraded copy of the media while memory resources with fewer errors may host a less degraded copy of the media. Yet, while the method 200 has been described in a particular order, it may be appreciated that the order of execution of blocks 202-210 may be different.

For instance, a memory resource may be selected for allocation to a host device based on any order of attributes of the memory resource, such as resource latency, error history, whether the memory resource hosts requested media, whether the memory resource hosts a signed image version of the media, whether a memory resource is available to be shared, or the like. As an illustrative example, in some cases, the resource composer may identify a set of memory resources that have the fewest errors in their error history. From this set, the resource composer may identify a subset of memory resources based on resource latency, and the resource composer may then select a memory resource to allocate.

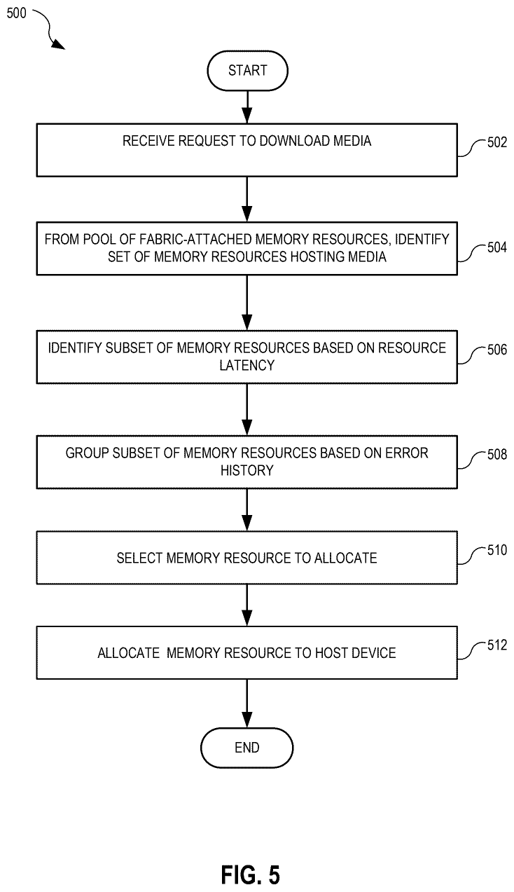

An additional example is illustrated in FIG. 5, which shows a flow diagram depicting a method 500 for allocating a memory resource to a host device. According to the method 500, the resource composer may identify memory resources hosting requested media and may subsequently select a resource from among the identified resources based on latency and/or error history.

The method 500 may include method blocks 502, 504, 506, 508, 510, and 512 (hereinafter collectively referred to as blocks 502-512) which may be performed by a computing device such as, for example, the resource composer 106 (FIG. 1). In particular, operations at each of the method blocks 502-512 may be performed by the computing device, such as a resource composer, by executing the instructions stored in a machine-readable medium, as described below with reference to FIG. 9

Moreover, it is to be noted that in some examples, the order of execution of the blocks 502-512 may be different than that shown in FIG. 5. For example, blocks may be added or omitted, and the blocks 502-512 may be performed in series, in parallel, or a series-parallel combination.

Method 500 may start at block 502, where a resource composer, such as resource composer 106 (FIG. 1), may receive a request to download media. The resource composer may generally perform the operations of block 502 as described herein with respect to block 202 of FIG. 2. In this regard, the request may be a request to download the media from a pool of fabric-attached memory resources.

At block 504, the resource composer may, from a pool of fabric-attached memory resources, identify a set of memory resources hosting media. The resource composer may identify a set of memory resources hosting media requested at block 502. In some cases, the request received at block 502 may be a request to download one or more media. For instance, the request may be a request to download one or more of a first media or a second media. In such cases, the resource composer may identify memory resources hosting either the first media or the second media to be included in the set. Further, in some cases, the resource composer may identify the set of memory resources based on each of the memory resources in the set hosting a signed image version of the media. In such cases, memory resources hosting an unsigned image version of the media may be omitted from the set.

At block 506, the resource composer may identify a subset of memory resources based on resource latency. The resource composer may identify this subset from the set of memory resources hosting media identified at block 502. In some cases, the resource composer may generally perform the operations of block 506 as described herein with respect to block 204 of FIG. 2. In this regard, the resource composer may identify a subset of memory resources having a lowest resource latency between the host device and/or with a respective resource latency satisfying a threshold. In some cases, for example, the resource composer may identify the subset of memory resources by grouping the set of memory resources based on resource latency and identifying the subset as the group of memory resources having the lowest resource latency.

At block 508, the resource composer may group the subset of memory resources based on error history. In some cases, the resource composer may generally perform the operations of block 508 as described herein with respect to block 206 of FIG. 2. In this regard, the resource composer may subdivide the subset of memory resources identified at block 506 into different groups based on a respective error history of the memory resources in the subset.

At block 510, the resource composer may select a memory resource to allocate. In some cases, the resource composer may generally perform the operations of block 510 as described herein with respect to block 208 of FIG. 2. Accordingly, the resource composer may select the memory resource from among the groups created at block 508 and may prioritize selecting a memory resource from a group with the fewest and/or least serious errors in its error history.

At block 512, the resource composer may allocate the selected memory resource to the host device. In some cases, the resource composer may generally perform the operations of block 512 as described herein with respect to block 210 of FIG. 2.

In some cases, for a given request, the method 500 and the method 200 (FIG. 2) may result in the same memory resource being allocated to a host device. In others, the method 500 and the method 200 may result in different memory resources being allocated to the host device. For instance, if a requested media is hosted on a memory resource with a resource latency exceeding the lowest resource latency and/or that fails to satisfy a threshold, the method 500 may result in a different allocation than method 200.

Further, while method 500 is described herein in a particular order, in some cases, the order of execution of block 506 and block 508 may be flipped. In such cases, the resource composer may group memory resources based on error history. The resource composer may identify, from a group with the fewest errors in its error history, memory resources based on resource latency. By grouping based on error history prior to resource latency, the resource composer may prioritize better error history (e.g., resource health) over resource latency. In this regard, in certain cases, method 500 may result in a different memory resource being allocated to the host device based on the order of blocks 506 and 508.

In some cases, the techniques described herein may be used to select and allocate a memory resource hosting an image to a host device. As described with reference to FIG. 6, the techniques may additionally or alternatively be used to identify a memory resource with optimal attributes (e.g., low or lowest resource latency, few or fewest errors in its error history, or the like) that may be used to host media. In this regard, the resource composer may identify a memory resource and may direct an imager host device to write content of media onto the identified memory resource.

Referring now to FIG. 6, a flow diagram depicting a method 600 for identifying a memory resource to host media is shown, in accordance with an example. The method 600 may include method blocks 602, 604, 606, 608, and 610 (hereinafter collectively referred to as blocks 602-610) which may be performed by a computing device such as, for example, the resource composer 106 (FIG. 1). In particular, operations at each of the method blocks 602-610 may be performed by the computing device, such as a resource composer (e.g., resource composer 106 (FIG. 1)), by executing the instructions stored in a machine-readable medium, as described below with reference to FIG. 9.

Moreover, it is to be noted that in some examples, the order of execution of the blocks 602-610 may be different than that shown in FIG. 6. For example, blocks may be added or omitted, and the blocks 602-610 may be performed in series, in parallel, or a series-parallel combination.

Method 600 may start at block 602, where a resource composer, such as resource composer 106 (FIG. 1), may receive a request to host media in a pool of fabric-attached memory resources. In some examples, the resource composer may receive the request from a host device, such as host device 102 (FIG. 1).

In some cases, the request received at block 602 may be substantially similar to the request received at block 202 (FIG. 2) described herein. In this regard, the request may be a request to download media at a host device from a memory resource in the pool of fabric-attached memory resources. In other cases, the request may be a request to write (e.g., copy) the media to a memory resource. In such cases, a request to download the media may subsequently be received from the same or a different computing device (e.g., host device).

At block 604, the resource composer may, from a pool of fabric-attached memory resources, identify a set of memory resources based on resource latency. In some cases, the resource composer may generally perform the operations of block 604 as described herein with respect to block 204 of FIG. 2. In this regard, the resource composer may identify the set of memory resources having the lowest resource latency. The resource composer may, for example, group the set of memory resources based on resource latency and identify the set as the group of memory resources having the lowest resource latency. In some cases, the resource composer may identify the set as a set of memory resources with a respective resource latency satisfying a threshold.

At block 606, the resource composer may group the set of memory resources based on error history. The resource composer may generally perform the operations of block 606 as described herein with respect to block 206 of FIG. 2.

At block 608, the resource composer may select the memory resource meeting media requirements. In some examples, selecting a memory resource meeting media requirements involves selecting a memory resource capable of hosting the media requested to be hosted (at block 602). Media requirements may include, for example, storage space to host the media, a link bandwidth to receive the media, a link bandwidth for a host device to access the media from the memory resource, and/or the like. In some cases, the resource composer may select a memory resource currently hosting a media responsive to determining that the memory resource may be overwritten with the requested media.

At block 610, the resource composer may direct the imager host device to write the media (e.g., write content of the media) onto the selected memory resource. The resource composer may direct an imager host device, such as imager host device 108 (FIG. 1), to write the content of the media onto the selected memory resource using, for example, API calls. As an illustrative example, the resource composer may direct the imager host device using Redfish API calls.

In some examples, the resource composer may perform the method 200 (FIG. 2) and method 600 (FIG. 6) separately. In other examples, the resource composer may perform the method 200 (FIG. 2) and method 600 (FIG. 6) jointly or concurrently. To that end, while illustrated and described as separate methods, operations of method 200 and method 600 may overlap and may be combined. For instance, allocating a memory resource to a host device (e.g., block 210 of FIG. 2) may involve directing an imager host device to write the media onto the selected memory resource (e.g., block 610 of FIG. 6). In this regard, the resource composer may, at block 210 of method 200, select a memory resource that is not hosting the media and may direct the imager host device to write the media (e.g., write content of the media) onto the selected memory resource in response (at block 610 of method 600). In some cases, the resource composer may, at block 210 of method 200, select a memory resource that is not hosting the media in response to determining the media is not hosted within a set determined based on resource latency and/or a group determined based on error history.

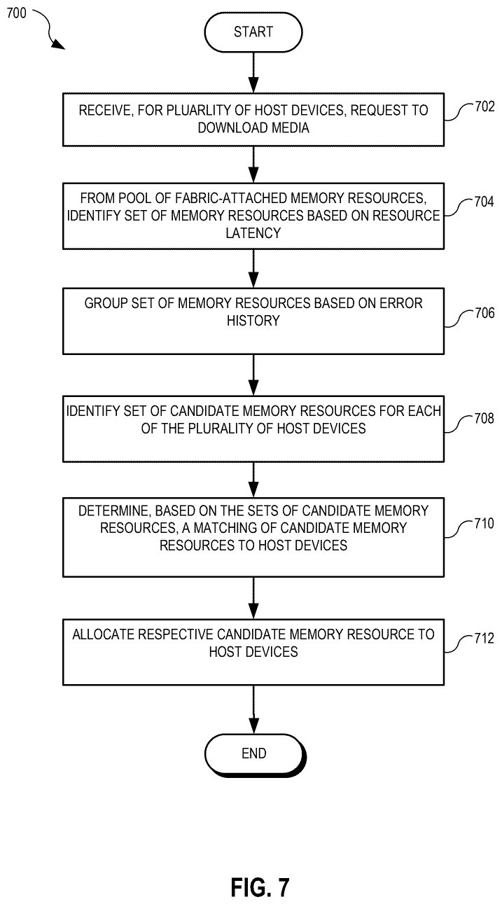

While methods described herein with respect to allocating a memory resource to a single host device, a data center may include hundreds of host devices, which may each request media to download. Moreover, these requests may be made concurrently and/or the subsequent downloading of media to the host devices may occur concurrently. Allocating memory resources to multiple host devices may involve performing the operations described above for each host device. In this regard, for each host device, the resource composer may select and allocate a respective memory resource based on attributes, such as resource latency, error history, media, of the resource. Additionally or alternatively, a resource composer may identify candidate memory resource(s) for a plurality of host devices, as described with respect to FIG. 7.

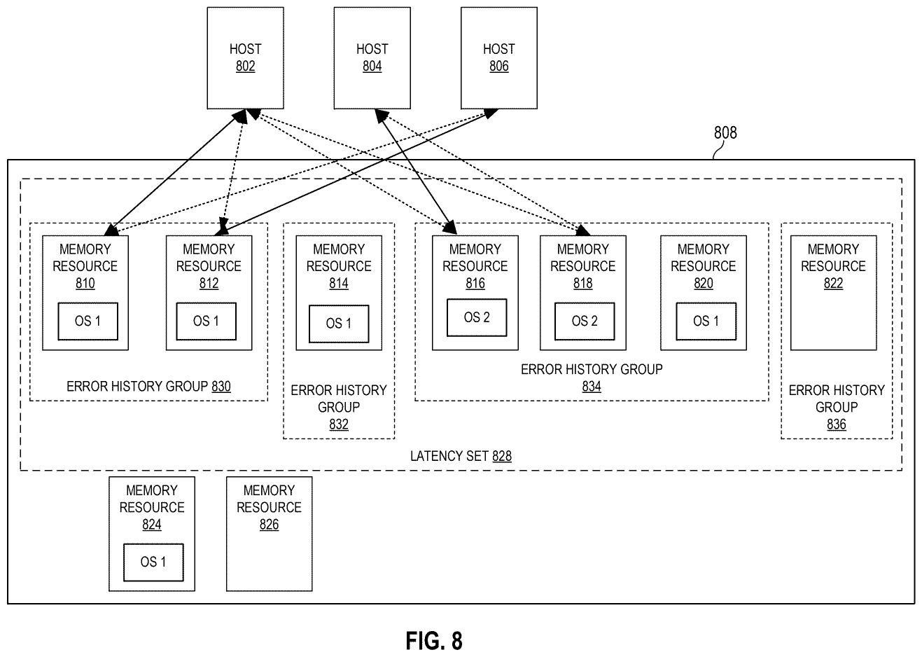

FIG. 7 illustrates a flow diagram depicting a method 700 for allocating memory resource(s) to a plurality of host devices, in accordance with an example. For illustration purposes, the method 700 will be described in conjunction with the example memory resource allocation shown in FIG. 8. The method 700 may include method blocks 702, 704, 706, 708, 710, and 712 (hereinafter collectively referred to as blocks 702-712) which may be performed by a computing device such as, for example, the resource composer 106 (FIG. 1). In particular, operations at each of the method blocks 702-712 may be performed by the computing device, such as a resource composer, by executing the instructions stored in a machine-readable medium, as described below with reference to FIG. 9.

Moreover, it is to be noted that in some examples, the order of execution of the blocks 702-712 may be different than that shown in FIG. 7. For example, blocks may be added or omitted, and the blocks 702-712 may be performed in series, in parallel, or a series-parallel combination.

Method 700 may start at block 702, where a resource composer, such as resource composer 106 (FIG. 1), may receive, for a plurality of host devices, a request to download media. In some examples, the resource composer may receive, for the plurality of host devices, a request to download a respective set of media from a pool of fabric-attached memory. For a given host device, the respective set of media may include one or more media, such as one or more of a first media and a different, second media. For instance, a given host device may request a first operating system or a second operating system.

In some examples, the resource composer may receive a respective request from each host device. In other examples, the resource composer may receive a request for multiple host devices. For instance, a single request may include a request to download a first media at a first host device, as well as a request to download a second media at a second device.

In the example allocation illustrated in FIG. 8, the resource composer may receive a request to download a respective set of media at a first host device 802, a second host device 804, and a third host device 806 from a pool 808 of fabric-attached memory resources. As described, the resource composer may receive a separate request from each host device or may receive a request that corresponds to each of the host devices 802-806.

In the illustrated example, the set of media requested for download at the first host device 802 includes a first operating system (labeled “OS 1”) and a second operation system (labeled “OS 2”). The set of media requested for download at the second host device 804 includes the second operating system, and the set of media requested for download at a third host device 806 includes the first operating system.

The first host device 802, the second host device 804, and the third host device 806 may each be an example of the host device 102 (FIG. 1). The pool 808 of fabric-attached memory resources may include fabric-attached memory resources (e.g., memory resources 810-826) accessible to (e.g., capable of being in communication with) the host devices 802-806. In this regard, while not shown, each of the memory resources 810-826 in the pool 808 may be coupled to the host devices 810-826 via a path including one or more FAM switches, such as FAM switch 104 (FIG. 1). Each of the memory resources 810-826 may be the memory space or a portion thereof provided by a memory device. For instance, a fabric-attached memory resource may be the memory provided by an SLD memory device (e.g., memory device 110 (FIG. 1)), a partition of the memory provided by an MLD memory device (e.g., memory device 114 (FIG. 1)), or the like. Moreover, while labeled “Memory Resource,” it may be appreciated that the memory resources 810-826 are fabric-attached memory resources.

At block 704, the resource composer may, from a pool of fabric-attached memory resources, identify a set of memory resources based on resource latency. In some cases, the resource composer may identify the memory resources having the lowest resource latency between the plurality of host devices for the set. In this regard, the resource composer may identify the set of memory resources such that a lowest resource latency for the plurality of host devices is between the plurality of host devices and each of the set of memory resources. In some cases, the resource composer may, for each of the plurality of host devices, identify a set of memory resources based on the resource latency between a resource and the given host device being the lowest resource latency, for example. In performing the operations of block 706, the resource composer may perform operations described herein with respect to block 206 of FIG. 2. To that end, identifying the set of memory resources may involve grouping the memory resources based on resource latency and selecting the group having the lowest resource latency, where the resource latency may be a particular value or a range of values.

In some cases, the resource composer may identify the set of memory resources based on a respective resource latency between each of the set of memory resources and the plurality of host devices satisfying a threshold. For instance, for each of the plurality of host devices, the resource composer may identify a set of memory resources based on the resource latency between the resource and the given host device satisfying the threshold.

As illustrated in FIG. 8, in some cases, the set of memory resources identified at block 704 may overlap for different host devices. For instance, the resource composer may determine the latency set 828 based on a resource latency between each of memory resources 810-822 and the host devices 802-806. In some cases, the resource composer may identify the latency set 828 based on the latency between the host devices 802-806 and each of the memory resources of the latency set 828 being the lowest resource latency for each of the host devices 802-806. In such cases, the resource latency between the host devices 802-806 and each of the memory resources 824-826 may exceed the lowest resource latency. Additionally or alternatively, the resource latency between memory resources 810-822 and the first host device 802 may satisfy a threshold, the resource latency between memory resources 810-822 and the second host device 804 may satisfy the same threshold, and the resource latency between memory resources 810-822 and the third host device 806 may satisfy the same threshold, for example. Similarly, the resource latency between the host devices 802-806 and each of the memory resources 824-826 may fail to satisfy this threshold.

In some cases, the memory resources 810-818 in the latency set 828 may be the lowest latency resources (e.g., the memory resources having the lowest resource latency) and/or may satisfy a resource latency threshold for each of host devices 802-806 because the host devices 802-806 are physically located near one another. Additionally or alternatively, a similar topology (e.g., path) may exist between the memory resources 810-818 and the host devices 802-808. In any case, as illustrated, allocating memory resources to host devices 802-808 may involve allocating memory resources from the same latency set 828. Further, while only the host devices 802-806 and the latency set 828 are illustrated, it may be appreciated that other latency sets may be identified for other host devices requesting to download media.

At block 706, the resource composer may group the set of memory resources based on error history. The resource composer may generally perform the operations of block 706 as described herein with respect to block 206 of FIG. 2.

To illustrate block 706, in the example shown in FIG. 8, the resource composer may group memory resources 810-822 within the latency set 828 into a first error history group 830, a second error history group 832, a third error history group 834, and a fourth error history group 836. The number and/or severity of errors in a respective memory resource's error history may increase from the first error history group 830 to a second error history group 832, from the second error history group 832 to the third error history group 834, and from the third error history group 834 to the fourth error history group 836.

At block 708, the resource composer may identify a set of candidate memory resources for each of the plurality of host devices. In some cases, the resource composer may identify the set of candidate memory resources for a given host device from the groups of memory resources identified at block 706. In some cases, identifying the set of candidate memory resources may involve identifying the memory resources for a host device that satisfy certain attributes, such as resource latency, error history, media, or a combination thereof. For instance, the resource composer may identify resources within the groups that are hosting the respective media requested by a given host device. For a host device requesting a first media or a second media, for example, the resource composer may identify memory resources within the groups hosting either the first media or the second media.

Identifying the set of candidate memory resources may involve prioritizing memory resources hosting respective media that are included in a group associated with fewer errors in its error history over memory resources hosting respective media that are included in a group associated with greater errors. A first group of memory resources and a second group of memory resources provide an illustrative example, where each of the resources in the first group include fewer errors in their respective error histories. Given these groups, between two memory resources that each host a requested media, the resource composer may prioritize including a memory resource in the first group over a memory resource included in a second group. In cases where a resource composer determines that the first group lacks a memory resource hosting the requested media, the resource composer may identify a memory resource from the second group that hosts the requested media for inclusion in the set of candidate memory resources.

In some cases, the resource composer may include multiple resources from the same group for inclusion in the set of candidate memory resources. For instance two memory resources in the first group and hosting a first media may be included in a set of candidate memory resources, as each of these resources may share similar latency attributes, error history attributes, and may host a requested media. Similarly, for a request to download either a first media or a second media, a first memory resource hosting the first media and in the first group, as well as a second memory resource hosting the second media and in the first group, may be included in a set of candidate memory resources, as each of these resources may share similar latency attributes, error history attributes, and may host a requested media.

Further, in cases where a host device requests to download either of multiple media, the resource composer may identify different candidate resources for the different media. In some cases, for example, the resource composer may identify a first set of candidate memory resources that host a first media and may identify a second set of candidate memory resources that host a second media. In identifying the first set of candidate memory resources, the resource composer may prioritize candidate memory resources that host the first media and have fewer errors over other memory resources. Similarly, in identifying the second set of candidate memory resources, the resource composer may prioritize candidate memory resources that host the second media and have fewer errors over other memory resources. The resource composer may identify the second set of candidate memory resources independent of the first set. In this regard, memory resources from the first set of candidate memory resources and the second set of memory resources may be included in the same error history group or in different error history groups.

The arrows between host devices 802-806 and corresponding memory resources in FIG. 8 illustrate example sets of candidate memory resources that may be identified at block 708. Using the techniques described herein, for the first host device 802, which requested the first operating system or the second operating system, the resource composer may identify memory resources 810, 812, 816, and 818 as a set of candidate memory resources. For the second host device 804, which requested the second operating system, the resource composer may identify memory resources 816-818 as a set of candidate memory resources. For the third host device 806, which requested the first operating system, the resource composer may identify memory resource 810-812 as a set of candidate memory resources.

As illustrated, the set of candidate memory resources for the first host device 802 includes multiple memory resources in the same error history group (e.g., memory resource 810-812). This set further includes resources hosting a first operating system (e.g., memory resource 810-812), as well as resources hosting a second operating system (e.g., memory resource 816-818), and the resources for each operating system are spread across different error history groups. As further illustrated by FIG. 8, memory resources in the set of candidate memory resources for each of the host devices 802-806 overlap with one another. For instance, the set of candidate memory devices for the first host device 802 and the set of candidate memory devices for the second host device 804 each include the memory resource 816.

At block 710, the resource composer may determine, based on the sets of candidate memory resources, a matching of candidate memory resources to host devices. In this regard, for a host device, the resource composer may select a memory resource of that host device's set of candidate resources to allocate to the host device. In some examples, from the sets of candidate resources, a matching may be determined that optimizes memory resource allocation across multiple host devices.

As an illustrative example, a first and a second memory resource may be identified as candidate resources for a first host device, and the first memory resource and a third memory resource may be identified as candidate resources for a second host device. In some cases, a matching may allocate the first memory resource to the first host device and may allocate the third memory resource to the second host device.

In some examples, the matching may be illustrated by a multipartite graph. In this regard, each host device may be a vertex in a first set of vertices, while each memory resource may be a vertex in a second set of vertices for the graph. The candidate resources for the host devices may be the edges of the graph. In FIG. 8, for example, the arrows between the host devices 802-806 (e.g., the first set of vertices) and the candidate memory resources 810-812 and 816-818 (e.g., the second set of vertices) may represent the edges of the graph. The matching may be a subset of the edges that match each of the host devices (e.g., each of the first vertices) to one or the memory resources (e.g., one of the second set of vertices). As an illustrative example, the arrows with filled, rather than dashed lines in FIG. 8 may represent a matching. In this regard, memory resource 810 may be selected for the first host device 802, memory resource 816 may be selected for the second host device 804, and memory resource 812 may be selected for the third host device 806.

In some examples, the resource composer may determine a matching based on optimizing attributes, such as resource latency and error history (e.g., resource health), across multiple host devices. For instance, the resource composer may prioritize a matching that provides separate memory resources for host devices over a matching that results in host devices sharing a memory resource. In FIG. 8, for example, although memory resource 810 is a candidate memory resource for both the first host device 802 and the third host device 806, the resource composer may match memory resource 810 to the first host device 802 and memory resource 812 to the third host device 806.

For a given host device, the resource composer may prioritize selecting a memory resource with fewer errors in its error history over other candidate memory resources. In FIG. 8, for example, the resource composer may select the memory resource 810 over the memory resource 816 for the first host device 802, as the memory resource 810 is included in the first error history group 830 while the memory resource 816 is included in the third error history group 834.

Further, while examples described herein relate to identifying a latency set (e.g., latency set 828) and grouping the set based on error history, examples may involve identifying a set of memory resources based on error history and grouping the set based on resource latency. In such examples, for candidate memory resources having a similar error history (e.g., within the same set), the resource composer may prioritize selecting a memory resource with lower resource latency over other candidate memory resources.

At block 712, the resource composer may allocate a respective candidate memory resource to the host devices. In some examples, the resource composer may allocate a candidate memory resource to a given host device based on the matching determined at block 710. In this regard, from the set of candidate memory resources, the resource composer may allocate respective candidate memory resource to each host device. The allocation of a given resource to host device may be performed as described with respect to block 210 (FIG. 2). In this regard, based on the allocation, a given host device may access requested media from a candidate memory resource. In cases where a host device requested a set of media, such as a first media or a second media, the host device may access the first media or the second media at the candidate memory resource.

In FIG. 8, for example, resource composer may allocate memory resource 810 to the first host device 802, memory resource 816 to the second host device 804, and memory resource 812 to the third host device 806. Accordingly, first host device 802 may access the first operating system at the memory resource 810, the second host device 804 may access the second operating system at memory resource 816, and the third host device 806 may access the first operating system at the memory resource 812.

In some examples, block 710 may optionally be included in method 700. For instance, the method 700 may proceed from block 708 directly to block 712. In such cases, at block 712, the resource composer may allocate each of the set of candidate resources to respective host devices. Based on this allocation, a host device may determine which resource, from among the set of its candidate resources, to download media from.

With respect to FIG. 8, for example, allocating each of the set of candidate resources to a host device (e.g., omitting determining a matching at block 710) may involve allocating memory resources 810, 812, 816, and 818 to the first host device 802. The resource composer may further allocate memory resources 816-818 to the second host device 804 and may allocate memory resource 810-812 to the third host device 806.

In some cases, allocating a respective set of candidate memory resources to the host devices may involve binding a given host device to each of its respective set of candidate resources. The resource composer may, for example, communicate the allocation to the host device (e.g., to the BMC 136 (FIG. 1) of the host device). The resource composer may further update a record usage for each of the memory resources. Additionally or alternatively, the resource composer may communicate the set of candidate memory resources available to the host device, and the host device may select a memory resource from among the set for binding. In some cases, the host device may communicate this selection to the resource composer, the resource composer may update the usage of the selected memory resource, and the host device may access the requested media at the selected memory resource.

FIG. 9 is a block diagram of a computing device 900 for allocating a fabric-attached memory resource to a host device, according to an example. The computing device 900 includes, for example, a processing resource 910, and a machine-readable storage medium 920 including instructions 922, 924, 926, 928, and 930 (hereinafter collectively referred to as instructions 922-930) for allocating a fabric-attached memory resource to a host device. Computing device 900 may be, for example, a server, client computer, notebook computer, a slate computing device, a portable reading device, a wireless email device, a mobile phone, or any other computing device. Further, computing device 900 may be an example of resource composer 106 (FIG. 1).

Processing resource 910 (e.g., processing element) may be, one or multiple central processing unit (CPU), one or multiple semiconductor-based microprocessor, one or multiple graphics processing unit (GPU), other hardware devices suitable for retrieval and execution of instructions stored in machine-readable storage medium 920, or combinations thereof. The processing resource 910 can be a physical device. Moreover, in one example, the processing resource 910 may include multiple cores on a chip, include multiple cores across multiple chips, multiple cores across multiple devices (e.g., if the computing device 900 includes multiple node devices), or combinations thereof. Processing resource 910 may fetch, decode, and execute instructions 922-930 to allocate a fabric-attached memory resource to a host device. As an alternative or in addition to retrieving and executing instructions, processing resource 910 may include at least one integrated circuit (IC), other control logic, other electronic circuits, or combinations thereof that include a number of electronic components for performing the functionality of instructions 922-930.

Machine-readable storage medium 920 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 920 may be encoded with a series of executable instructions, including instructions 922-930, for performing the method 200 described in FIG. 2. Although not shown, in some examples, machine-readable storage medium 920 may be encoded with certain additional executable instructions to perform the operations of the method 400 described in FIG. 4, the method 500 described in FIG. 5, the method 600 described in FIG. 6, the method 700 described in FIG. 7, and/or any other operations performed by the resource composer 106 (FIG. 1), without limiting the scope of the present disclosure.

The receive request instructions 922 may be executable to receive, from a host device, a request to download media from a pool of fabric-attached memory resources. The identify memory resources based on resource latency instructions 942 may be executable to, responsive to the request and from the pool of fabric-attached memory resources, identify a set of memory resources based on resource latency such that a lowest resource latency for the host device is between the host device and each of the set of memory resources. The group memory resources based on error history instructions 926 may be executable to group, based on a respective error history of a given memory resource, the set of memory resources into a first group and a second group, where the respective error history of each of the memory resources in the first group includes fewer errors than the respective error history of each of the memory resources in the second group. The select memory resource to allocate instructions 928 may be executable to select, from the first group, a memory resource to allocate to the host device. The allocate memory resource instructions 930 may be executable to allocate the memory resource to the host device, where based on the allocating, the media is accessible to the host device at the memory resource.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A method, comprising:
receiving, from a host device, a request to download media from a pool of fabric-attached memory resources;
responsive to the request and from the pool of fabric-attached memory resources, identifying a set of memory resources based on resource latency such that a lowest resource latency for the host device is between the host device and each of the set of memory resources;
grouping, based on a respective error history of a given memory resource, the set of memory resources into a first group and a second group, wherein the respective error history of each of the memory resources in the first group includes fewer errors than the respective error history of each of the memory resources in the second group;
selecting, from the first group, a memory resource to allocate to the host device; and
allocating the memory resource to the host device, wherein, based on the allocating, the media is accessible to the host device at the memory resource.

2. The method of claim 1, comprising selecting the memory resource further based on determining the memory resource hosts the media.

3. The method of claim 1, wherein the request to download the media is to download one or more of a first media and a second media, comprising:
selecting the memory resource responsive to determining the memory resource hosts the first media or the second media.

4. The method of claim 1, wherein the request is further to download a second media at the host device, comprising:
responsive to determining the second media is not hosted in the first group, determining a second memory resource from the second group hosts the second media;
selecting the second memory resource to allocate to the host device; and
allocating the second memory resource to the host device, wherein, based on the allocating, the second media is accessible to the host device at the second memory resource.

5. The method of claim 1, wherein the media is accessible to a second host device at the memory resource, and wherein selecting the memory resource comprises selecting the memory resource further based on determining the memory resource is available to be shared by the host device and the second host device.

6. The method of claim 5, comprising determining the memory resource is available to be shared based on a bandwidth of the memory resource.

7. The method of claim 1, comprising selecting the memory resource further based on determining the memory resource hosts a signed image version of the media.

8. The method of claim 1, wherein allocating the memory resource to the host device comprises directing an imager host device hosting the media to write content of the media onto the memory resource.

9. The method of claim 1, wherein the media comprises a bootable image.

10. The method of claim 1, wherein selecting the memory resource comprises:
identifying, for the host device, a set of candidate memory resources, by:
identifying, from the first group or second group, one or more memory resources hosting the media; and
prioritizing memory resources hosting the media from the first group over the second group for inclusion in the set of candidate memory resources,
wherein the set of candidate memory resources comprises the memory resource.

11. The method of claim 10, wherein allocating the memory resource to the host device comprises allocating the set of candidate memory resources to the host device.

12. The method of claim 10, comprising
receiving, from a second host device, a request to download a second media;
identifying, for the second host device, a second set of candidate memory resources, by:
identifying, from the first group or second group, a second one or more memory resources hosting the second media; and
prioritizing memory resources hosting the second media from the first group over the second group for inclusion in the second set of candidate memory resources; and
selecting the memory resource further based on the set of candidate resources and the second set of candidate resources.

13. A system comprising:
a processing resource; and
a non-transitory machine-readable storage medium comprising instructions executable by the processing resource to:
receive, from a host device, a request to download media from a pool of fabric-attached memory resources;
responsive to the request and from the pool of fabric-attached memory resources, identify a set of memory resources hosting the media;
from the set of memory resources hosting the media, identify a subset of memory resources based on resource latency, wherein a respective resource latency between each of the subset of memory resources and the host device satisfies a threshold;
group, based on a respective error history of a given memory resource, memory resources from the subset into a first group and a second group, wherein the respective error history of each of the memory resources in the first group includes fewer errors than the respective error history of each of the memory resources in the second group;
select, from the first group, a memory resource to allocate to the host device; and
allocate the memory resource to the host device, wherein, based on the allocating, the media is accessible to the host device at the memory resource.

14. The system of claim 13, wherein the instructions are further executable to:
cache an allocation of the memory resource to the host device; and
responsive to receiving a second request from the host device, allocate the memory resource to the host device based on the cache.

15. The system of claim 13, wherein the threshold is a lowest resource latency for the host device.

16. A non-transitory machine-readable storage medium comprising instructions executable by a processing resource of a computing device to:
receive, for a plurality of host devices, a request to download a respective set of media from a pool of fabric-attached memory, wherein for a given host device, the respective set of media includes one or more of a first media and a second media;
responsive to the request and from the pool of fabric-attached memory resources, identify a set of memory resources based on resource latency such that a lowest resource latency for the plurality of host devices is between the plurality of host devices and each of the set of memory resources;
group, based on a respective error history of a given memory resource, the set of memory resources into a first group and a second group, wherein the respective error history of each of the memory resources in the first group includes fewer errors than the respective error history of each of the memory resources in the second group;
identify, for each host device of the plurality of host devices, a respective set of candidate memory resources, by, for each media of a given respective set of media:
identifying, from the first group or second group, one or more memory resources hosting the given media; and
prioritizing identified memory resources hosting the given media from the first group over the second group for inclusion in the respective set of candidate memory resources; and
allocate, to each host device of the plurality of host devices, a respective candidate memory resource from the respective set of candidate memory resources.

17. The non-transitory machine-readable storage medium of claim 16, wherein a given host device may access the first media or the second media from the allocated respective candidate memory resource.

18. The non-transitory machine-readable storage medium of claim 16, wherein the instructions are further executable to:
determine, based on each set of candidate memory resources, a matching of candidate memory resources to the plurality of host devices; and
select the respective candidate memory resource to allocate to each host device based on the matching.

19. The non-transitory machine-readable storage medium of claim 16, wherein, to allocate the respective candidate memory resource, the instructions are further executable to:
allocate, to each host device, the respective set of candidate memory resources.

20. The non-transitory machine-readable storage medium of claim 16, wherein to prioritize memory resources hosting the given media from the first group, the instructions are further executable to:
responsive to determining a memory resource from the first group hosts the given media, include the memory resource in the respective set of candidate memory resources; and
responsive to determining the given media is not hosted in the first group, adding a memory resource from the second group in the respective set of candidate memory resources.
